(19) United States
(12) Patent Application Publication
(10) Pub. No.: US 2015/0149586 A1
(43) Pub. Date: May 28, 2015

(54) INFORMATION PROCESSING APPARATUS, INFORMATION PROCESSING METHOD, AND INFORMATION PROCESSING SYSTEM

(71) Applicant: Satoshi SAITO, Saitama (JP)

(72) Inventor: Satoshi SAITO, Saitama (JP)

(73) Assignee: Ricoh Company, Ltd., Tokyo (JP)

(21) Appl. No.: 14/515,859

(22) Filed: Oct. 16, 2014

(30) Foreign Application Priority Data
Nov. 27, 2013 (JP) 2013-245295

(51) Int. Cl. H04L 29/08

(52) U.S. Cl. CPC H04L 67/10; H04L 67/02
USPC 709/217

(57) ABSTRACT

An information processing apparatus that is connected to at least one terminal apparatus via a network, includes an acquisition part acquiring a set of data corresponding to a request from the terminal apparatus and an output control part connecting, when the acquisition part acquires plural sets of data, the plural sets of data to each other by inserting separating information between two sets of the data, and transmitting the connected plural sets of data to the terminal apparatus.

### CROSS-REFERENCE TO RELATED APPLICATIONS

The present application is based on and claims the benefit of priority under 35 U.S.C §119 of Japanese Patent Application No. 2013-245295 filed Nov. 27, 2013, the entire contents of which are hereby incorporated herein by reference.

### BACKGROUND OF THE INVENTION

1. Field of the Invention

The present invention generally relates to an information processing apparatus, an information processing method, and an information processing system.

2. Description of the Related Art

As a method of acquiring plural images which exist on a web site, there is a known method in which the server side generates a single large image from the plural images and the client acquires the single large image from the server. This method can be realized by using a Cascading Style Sheet (CSS) function (e.g., background-positioning property). On the other hand, there is a known method of acquiring images which exist on plural servers (see, for example, Japanese Patent No. 4329849).

### SUMMARY OF THE INVENTION

According to an aspect of the present invention, an information processing apparatus that is connected to at least one terminal apparatus via a network, includes an acquisition part acquiring a set of data corresponding to a request from the terminal apparatus and an output control part connecting, when the acquisition part acquires plural sets of data, the plural sets of data to each other by inserting separating information between two sets of the data, and transmitting the connected plural sets of data to the terminal apparatus.

### BRIEF DESCRIPTION OF THE DRAWINGS

Other objects, features, and advantages of the present invention will become more apparent from the following description when read in conjunction with the accompanying drawings, in which:

FIG. 1 illustrates an example configuration of a conference system according to an embodiment;

FIG. 2 illustrates an example hardware configuration of a computer included in the conference system;

FIG. 3 illustrates a functional block diagram of an example conference system according to an embodiment;

FIG. 4 illustrates an example configuration of a conference information table;

FIG. 5 illustrates an example configuration of a document information table;

FIG. 6 is a flowchart of an example conference registration process;

FIG. 7 illustrates an example conference registration screen of a conference application;

FIG. 8 illustrates an example conference list screen;

FIG. 9 illustrates an example conference screen;

FIG. 10 illustrates an example thumbnail list displayed on the conference screen;

FIG. 11 illustrates an example method of transmitting plural images;

FIG. 12 is a flowchart of an example image transmission process of a conference server apparatus;

FIG. 13 is a flowchart of an example thumbnail list display process; and

FIG. 14 illustrates example request data and response data.

### DETAILED DESCRIPTION OF THE PREFERRED EMBODIMENTS

Next, details of embodiments of the present inventions are described. In this embodiment, for explanatory purposes, a conference system is described as an example of an information processing system. However, it should be noted that the present invention is not limited to the conference system. Namely, the present invention may also be applied to, for example, a system that displays information.

### System Configuration

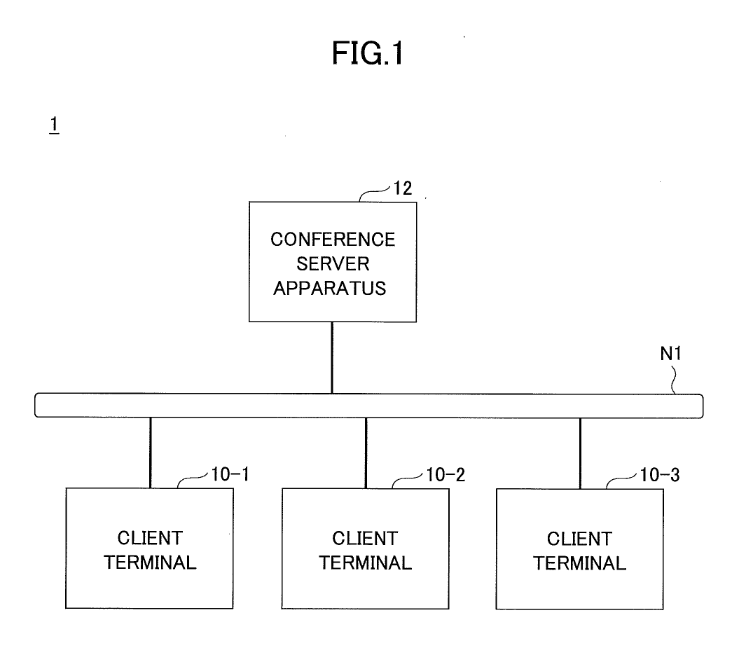

FIG. 1 illustrates an example configuration of a conference system according to an embodiment. As illustrated in FIG. 1, a conference system 1 includes one or more client terminal(s) 10 (in the example of FIG. 1, client terminals 10-1 through 10-3), and a conference server apparatus 12, which are connected via a (communication) network N1. Here, the network N1 refers to a network such as, for example, a Local Area Network (LAN) or the Internet so that the client terminals 10 and the conference server apparatus 12 are connected to each other wirelessly or with a wire.

The client terminals 10 herein refer to, for example, terminal devices that can be operated by the respective users. The client terminal 10 may be, for example, a laptop personal computer (PC), a tablet terminal, a smartphone, a cellular phone, etc. The client terminal 10 accesses the conference server apparatus 12, receives (downloads), for example, a conference document image from the conference server apparatus 12, and synchronously or asynchronously displays the conference document image. Here, the client terminal 10 may be, for example, an image forming apparatus such as a printer, a multifunction peripheral or the like, a projection device such as a projector or the like, or an electronic blackboard.

The conference server apparatus 12 is realized by one or more computers. The conference server apparatus 12 may be, for example, a Work Station (WS), a PC, etc. The conference server apparatus 12 performs information processing on the information related to the conference. The conference server apparatus 12 manages the conference (e.g., to generate, edit, delete, and search for a conference and to communicate with the client terminal(s) 10 during the conference).

The conference server apparatus 12 stores, for example, conference information which is registered by the client terminal(s) 10 or the like, the conference document image, etc. Further, for example, the conference server apparatus 12 transmits the conference document image to the client terminal 10 that requests to acquire the conference document.

The conference server apparatus 12 accumulates, for example, a HyperText Markup Language (HTML) document, a CSS file, a JavaScript (registered trademark) file, an image file, etc. The JavaScript file is an example of a file which is described in a script language (simplified program language). Here, it is assumed that the conference server apparatus 12 functions as the conference server. However, the hardware configuration of the conference server apparatus 12 is not limited to a specific configuration. In this regard, the conference server apparatus 12 may include a terminal or may use a so-called Cloud service.

### Hardware Configuration

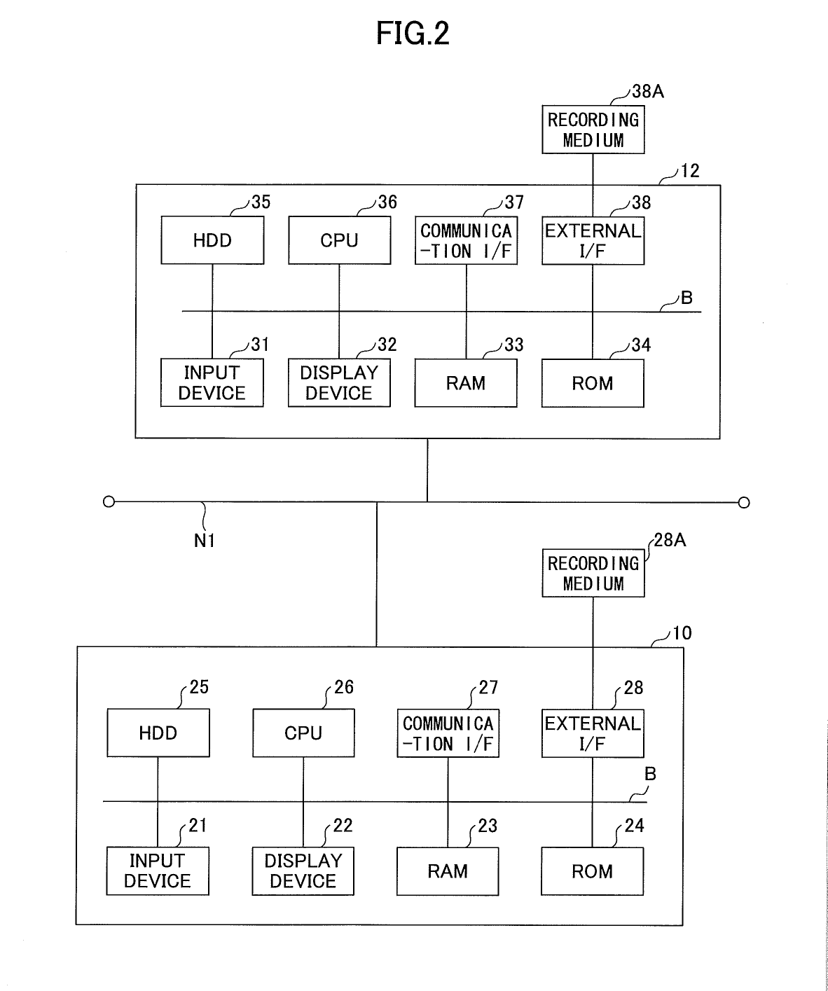

The client terminal(s) 10 and the conference server apparatus 12 may have, for example, a hardware configuration as illustrated in FIG. 2.

FIG. 2 illustrates an example hardware configuration of the computers included in the conference system 1 according to an embodiment. As illustrated in FIG. 2, the client terminal 10 includes an input device 21, a display device 22, a Random Access Memory (RAM) 23, a Read Only Memory (ROM) 24, a Hard Disk Drive (HDD) 25, a Central Processing Unit (CPU) 26, a communication interface (I/F) 27, and an external I/F 28, which are connected to each other via a bus B.

The input device 21 includes, for example, a keyboard, a mouse, a touch panel, etc., and is used to input various operation signals into the client terminal 10. The display device 22 includes a display or the like to display a processing result by the client terminal 10.

The RAM 23 is a volatile semiconductor memory (storage device) to temporarily store a program and data. The ROM 24 is a non-volatile semiconductor memory (storage device) that can store a program and data even when the power to it is turned off. In the ROM 24, programs and data are stored such as, for example, the Basic Input/Output System (BIOS) that is executed when the client terminal 10 is started up, OS settings, and network settings.

The HDD 25 is a non-volatile storage device storing programs and data. Such programs and data include an Operating System (OS) which is a basic software for controlling the entire client terminal 10 and application software programs that provide various functions running on the OS.

The CPU 26 is an arithmetic device that realizes the entire control and functions of the client terminal 10 by loading the programs and data from a storage device such as the ROM 24, the HDD 25 and the like to the RAM 23 and executing the processes.

The communication I/F 27 is provided to connect the client terminal 10 to the network N1. By having this, it becomes possible for the client terminal 10 to perform data communication with the conference server apparatus 12 via the communication I/F 27.

The external I/F 28 is an interface to an external device. Such an external device includes a recording medium 28A or the like. By having this, it becomes possible for the client terminal 10 to read and/or write programs and data with the recording medium 28A or the like via the external I/F 28.

Such a recording medium 28A includes a flexible disk, a Compact Disk (CD), a Digital Versatile Disk (DVD), an SD Memory card, a Universal Serial Bus (USB) memory, etc.

The client terminal 10 can realize (execute) various processes described below by having such a hardware configuration described above and executing the program. It should be noted that, for example, it is possible to add a hardware element such as a microphone, a speaker, a camera, etc., to the hardware configuration of the client terminal 10 in FIG. 2.

On the other hand, as illustrated in FIG. 2, the conference server apparatus 12 includes an input device 31, a display device 32, a RAM 33, a ROM 34, an HDD 35, a CPU 36, a communication I/F 37, and an external I/F 38, which are connected to each other via a bus B. Here, the input device 31 and the display device 32 may be included in (attached to) the conference server apparatus 12 when necessary.

The input device 31 includes, for example, a keyboard, a mouse, a touch panel, etc., and is used to input various operation signals into the conference server apparatus 12. The display device 32 includes a display or the like to display a processing result by the conference server apparatus 12.

The RAM 33 is a volatile semiconductor memory (storage device) to temporarily store a program and data. The ROM 34 is a non-volatile semiconductor memory (storage device) that can hold a program and data stored therein even when the power thereto is turned off. In the ROM 34, programs and data are stored such as, for example, the Basic Input/Output System (BIOS) that is executed when the conference server apparatus 12 is started up, OS settings, and network settings.

The HDD 35 is a non-volatile storage device storing programs and data. Such programs and data include an Operating System (OS) which is basic software for controlling the entire conference server apparatus 12 and application software programs that provide various functions running on the OS.

The CPU 36 is an arithmetic device that realizes the entire control and functions of the conference server apparatus 12 by loading the programs and data from a storage device such as the ROM 34, the HDD 35 and the like to the RAM 33 and executing the processes.

The communication I/F 37 is provided to connect the conference server apparatus 12 to the network N1. By having this, it becomes possible for the conference server apparatus 12 to perform data communication with client terminal 10 via the communication I/F 37.

The external I/F 38 is an interface to an external device. Such an external device includes a recording medium 38A or the like. By having this, it becomes possible for the conference server apparatus 12 to read and/or write programs and data with the recording medium 38A or the like via the external I/F 38. Such a recording medium 38A includes a flexible disk, a CD, a DVD, an SD Memory card, a USB memory, etc.

The conference server apparatus 12 can realize (execute) various processes described below by having such a hardware configuration described above and executing the program.

### Software Configuration

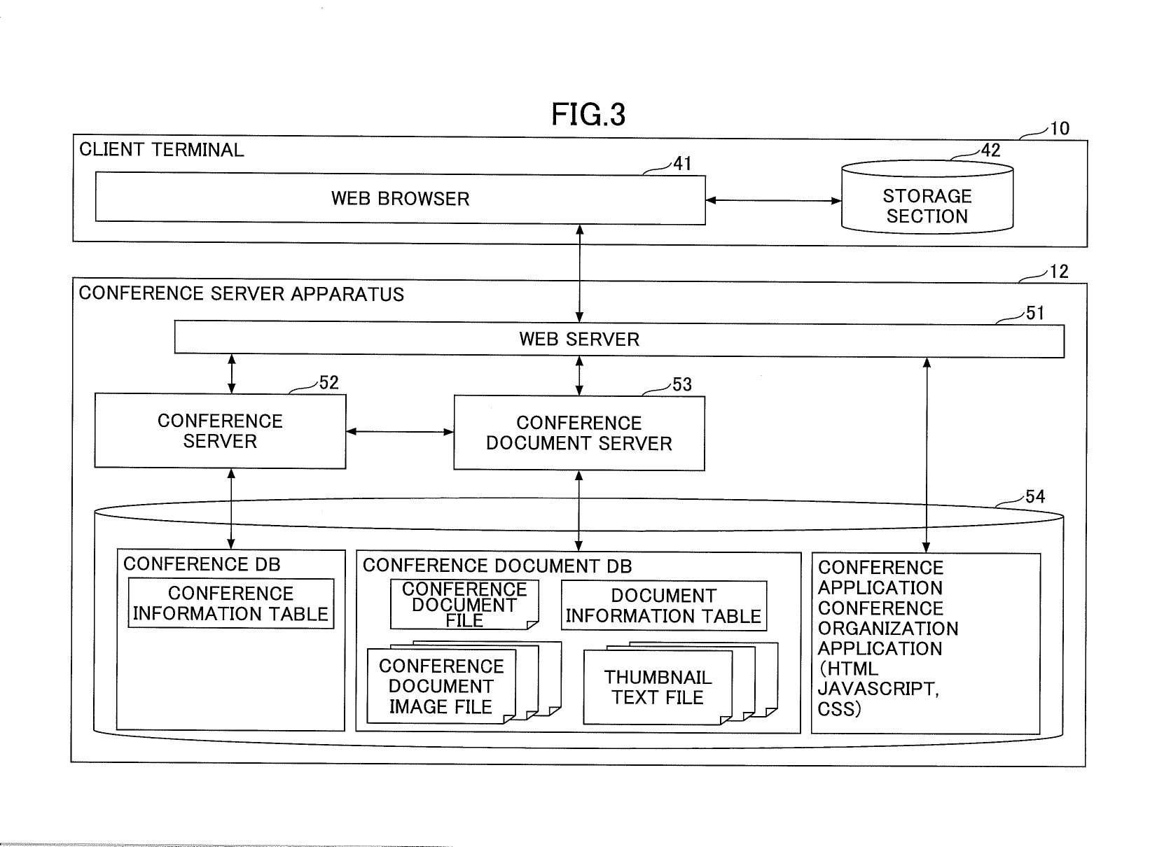

The conference system 1 according to this embodiment is realized by having, for example, functional blocks of FIG. 3. FIG. 3 is a functional block diagram of an example conference system according to this embodiment. With reference to FIG. 3, a conference system 1 is described where the conference server apparatus 12 communicates with the client terminal 10 using an instant messenger using, for example, an eXtensible Messaging and Presence Protocol (XMPP).

The XMPP is standardized by the Internet Engineering Task Force (IETF) as RFC3920 (Extensible Messaging Presence Protocol: Core), RFC3921 (Extensible Messaging and Presence Protocol: Instant Messaging and Presence), and, for example, the extensive specification is documented as XEP extensions (series).

In the XMPP, it is possible to provide services such as Group Chat (Multi-user Chat [XEP-0045]). Here, the “Group Chat” refers to a function in which when a client terminal(s) 10 participating in a Conference Room (“Room”), which is provided by the XMPP, sends a message to the conference server apparatus 12, the message is also sent to all the other client terminal(s) 10 which are participating in the Conference Room.

Further, in the XMPP, there are techniques including, for example, Bidirectional-Over Synchronous HyperText Transfer Protocol (HTTP) (BOSH) [XEP-0206] to transmit and receive a message over HTTP. By using the BOSH, it becomes possible for the conference server apparatus 12 to not only realize the XMPP communications over HTTP but also realize a Push function. The “Push function” refers to a function where information is not transmitted as a response to a request from the client terminal 10 but the information is transmitted from the conference server apparatus 12 to the client terminal 10 and the client terminal 10 receives the information.

As illustrated in FIG. 3, the client terminal 10 includes a WEB browser 41, which is an example of a display control part, and a storage section 42. The WEB browser 41 is used to, for example, acquire various information items such as conference documents on the conference server apparatus 12 and display screens of the acquired information. Note that the functions of the WEB browser 41 are not limited to those functions. For example, the WEB browser 41 may acquire necessary information from another external device connected to the network N1, and display a screen to display the acquired information.

The storage section 42 stores the information acquired by the WEB browser 41. Here, the storage section 42 may be realized by, for example, the HDD 25, the RAM 23, the ROM 24 or the like.

As illustrated in FIG. 3, the conference server apparatus 12 includes a WEB server 51, which is an example of a request receive part, a conference server 52, which is an example of a management part, a conference document server 53, which is an example of an acquisition part and an output control part, and an information storage section 54 which is an example of a storage part.

The information storage section 54 stores a conference database (DB), a conference document DB, a conference application, a conference organization application, etc. The conference DB stores, for example, a conference information table, etc. The conference document DB store, for example, a conference document file, a document information table, etc.

The conference document DB further stores, for example, a conference document image file which is converted from the conference document file, a conference document image file which is converted for thumbnail display purposes, a thumbnail text file which is further converted into a text format, etc.

The WEB server 51 includes, for example, an information transmission and receiving function.

The conference server 52 reflects various requests for generating, editing, and deleting the conference from the client terminal 10 and the like in the conference information table in the conference DB. The conference server 52 processes the various requests for, for example, organizing (holding), participating in, exiting, and terminating the conference from the client terminals 10.

The conference server 52 manages one or more conferences based on a conference type (e.g., conference IDs), and also manages conference date and time, a conference status, authentication using a password or the like, etc. During a conference, the conference server 52 manages conference sharing information (e.g., displayed conference documents, display pages of the conference documents, handwritten memo data, etc.). Here, the requests from the client terminals 10 to the conference server apparatus 12 are sent by, for example, a message using the XMPP.

The conference document server 53 has, for example, a data management function, a data conversion function, a data acquisition function, etc. Further, based on requests from the client terminals 10 to register the conference document files, the conference document server 53 stores the conference document files in the conference document DB, reflects the requests in the document information table, and manages the data.

Further, the conference document server 53 converts the conference document files stored in the conference document DB into the conference document image files for at least one of a standard display, an enlarged display, and a thumbnail display. The conference document server 53 converts the conference document image file for the thumbnail display into the thumbnail text file having a predetermined format (such as a text format or the like) by encoding using Base 64.

Based on requests from the client terminals 10 to acquire the conference document image files, the conference document server 53 acquires the conference document image files for the standard display and the enlarged display from the information storage section 54, and transmits the acquired conference document image files to the client terminals 10. Further, based on requests from the client terminals 10 to acquire a thumbnail list, the conference document server 53 acquires the corresponding thumbnail text files from the information storage section 54, and transmits the acquired thumbnail text files to the client terminals 10.

As the transmission method of transmitting the text file which is used herein, for example, the text files are combined by inserting a predetermined delimiter (separating character), as an example of delimiting information, in between the text files, so that the combined text file including the text files is formed and transmitted to the client terminal(s) 10. A specific example of the above transmission method is described below.

The information storage section 54 stores, for example, the conference application and the conference organization application which are to be executed on the WEB browser 41 included in the client terminal 10. Such a conference application and a conference organization application are realized by, for example, a HTML file (HTML document) and accompanying CSS file, JavaScript file, image file, etc., which are to be displayed on the WEB browser 41. The conference application and the conference organization application are downloaded from the conference server apparatus 12 to the client terminal(s) 10 and used.

In the conference system 1 of FIG. 3, by using, for example, an Asynchronous JavaScript XML (Ajax) technique, a Document Object Model (DOM) is operated, so that the content to be displayed on the WEB browser 41 is rewritten. Here, the “Ajax technique” refers to an implementation form in which a process is performed by transacting XML data using an HTTP communication function for a JavaScript file without reloading a Web page.

Note that the method of rewriting the content displayed on the WEB browser 41 is not limited to the method of updating the DOM. For example, in “HTML5”, it is possible to directly rewrite the content displayed on the WEB browser 41.

Further, in the conference system 1, the WEB browser 41 of the client terminal 10 uses the WEB server 51 to communicate with the conference server 52. Here, it is not appropriate to use the XMPP message to transmit a large amount of binary data as a method of uploading the conference document file and downloading the conference document image file and the text file. In this regard, in the conference system 1, the upload of the conference document file and the download of the conference document image file and the text file are performed by using, for example, an HTTP GET request and an HTTP POST request.

In the conference system 1, in accordance with the selection of the conference document file and the input (operation) of the display page and the like of the conference document file by a user, the XML data in JavaScript are generated and transmitted from the client terminal 10 to the conference server apparatus 12 as the Group Chat. Accordingly, the conference server apparatus 12 delivers the XML data to, for example, all the client terminals 10 participating the Conference Room.

The conference organization application, which runs on the WEB browser 41 of the client terminal 10, interprets the XML data, and receives the conference document image file corresponding to the display page of the conference document file and the text file to display the thumbnail list from the conference server apparatus 12.

Further, for example, the conference organization application may operate (update) the DOM to switch between a file for the standard display and a file for the enlarged display and display the selected file among conference document image files corresponding to the display page of the conference document file. Further, the conference organization application updates a text, a figure, a handwritten memo, etc., to be drawn on the displayed conference document image by operating (updating) the DOM.

### Conference Information Table

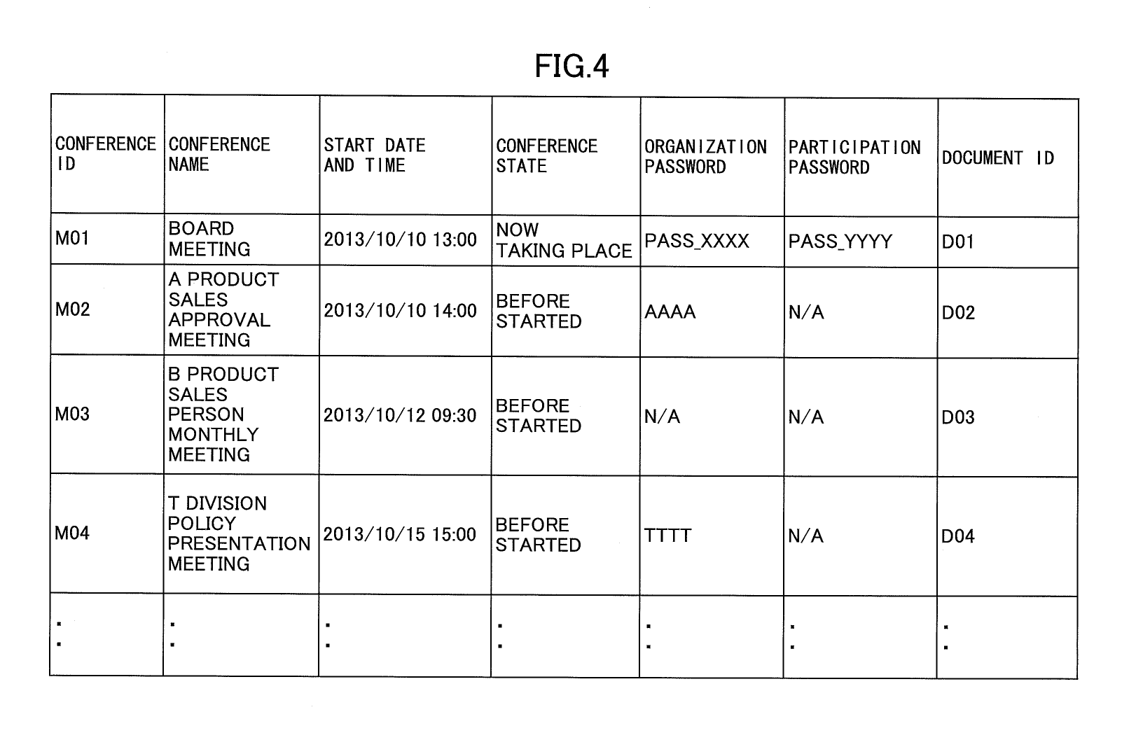

FIG. 4 illustrates an example conference information table. As illustrated in FIG. 4, the conference information table stored in the conference DB includes, for example, a “conference ID”, a “conference name”, “start date and time”, a “conference state”, an “organization password”, a “participation password”, and a “document ID”. Note that the configuration of the conference information table is not limited to that in this example.

The “conference ID” refers to the information that uniquely identifies the conference set by the conference server 52 in accordance with a request for generating (organizing) the conference from the client terminal 10. The “conference name” can be arbitrarily set by a user and is used for a user to identify the conference. The “start date and time” can be arbitrarily set by a user and refers to, for example, the date and time when the conference is scheduled to start.

The “conference state” indicates, for example, one of “before started”, “now taking place”, and “finished”. The “conference state” is set by the conference server 52 and is changed by the conference server 52 in accordance with the state. For example, when a conference is newly generated, the “conference state” is set to “before started”. When the conference is taking place, the “conference state” is changed to “now taking place”. When all the users who participated in the conference exit and the conference is finished, the “conference state” is changed to “finished”.

The “organization password” refers to the authentication information that is to be used when the conference is organized (generated). On the other hand, the “participation password” refers to the authentication information that is to be used to participate in the conference. When the “participation password” is set, any user who does not know the “participation password” cannot participate in the conference. The “document ID” refers to the information that is used to identify the conference document file, the conference document image file, and the thumbnail text file to be used in the conference.

### Document Information Table

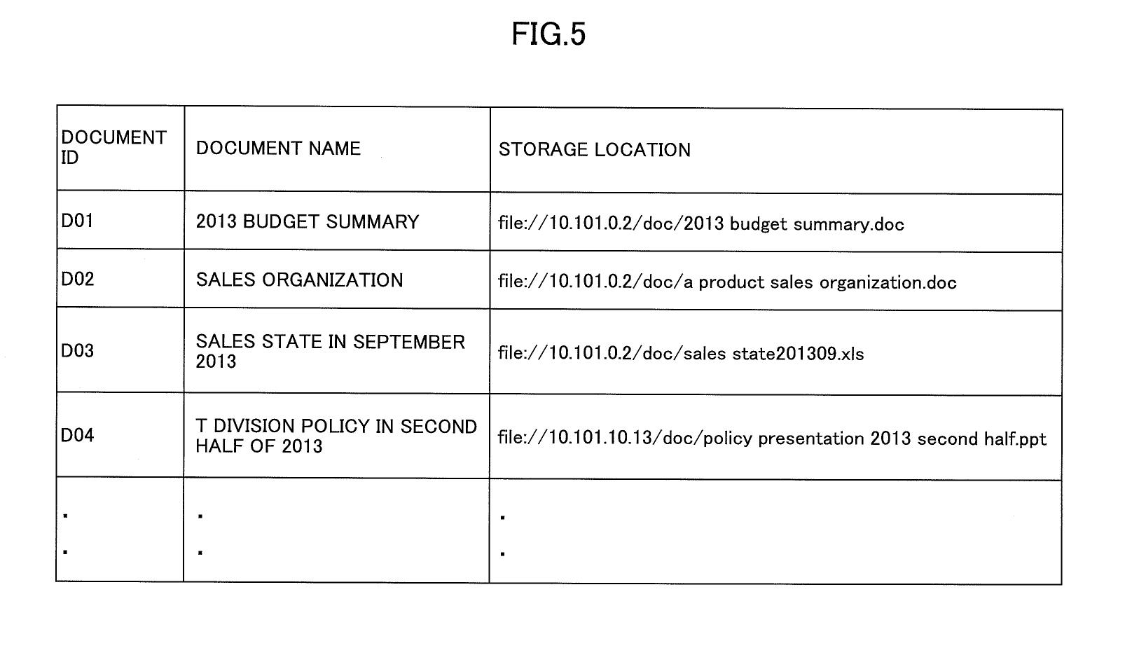

FIG. 5 illustrates an example document information table. As illustrated in FIG. 5, the document information table stored in the conference document DB includes, for example, the “document ID”, a “document name”, and a “storage location”. Note that the configuration of the document information table is not limited to that in this example. The “document ID” refers to the information that is used to identify the conference document file, the conference document image file, and the thumbnail text file to be used in the conference. The “document name” can be arbitrarily set by a user and is used for a user to identify the conference document file. The “storage location” indicates the storage location of the conference document file.

### Details of the Processes

In the following, details of the processes of the conference system 1 according to this embodiment are described.

### Conference Registration Process

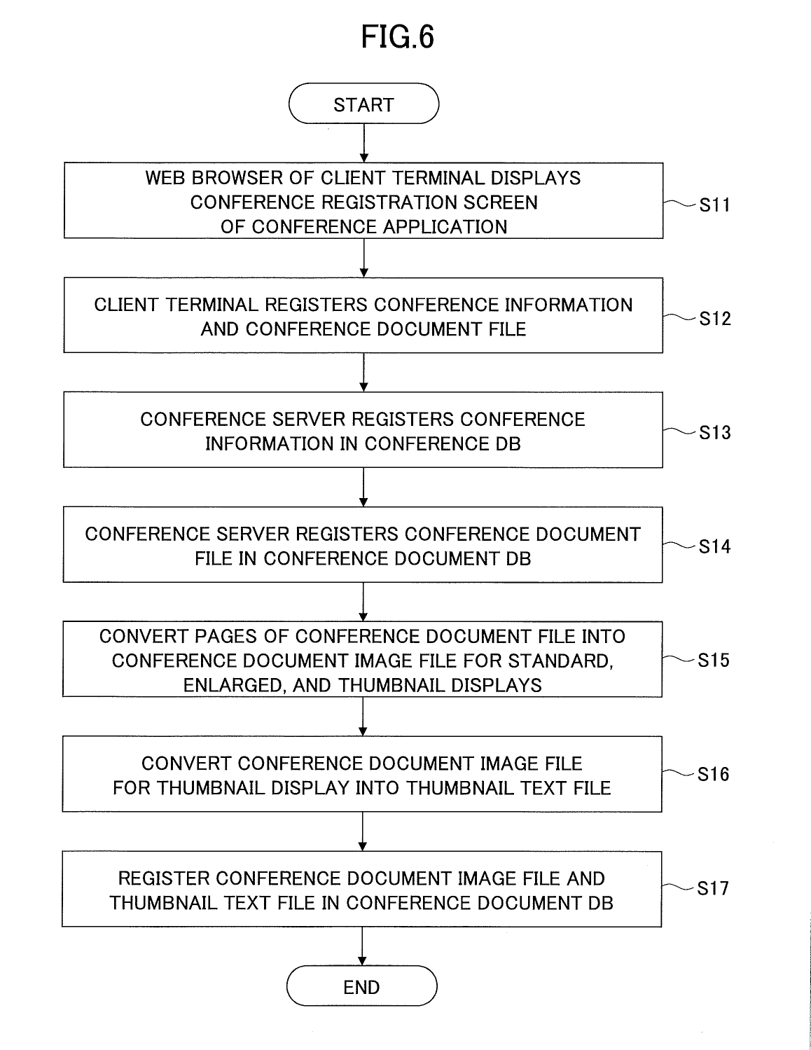

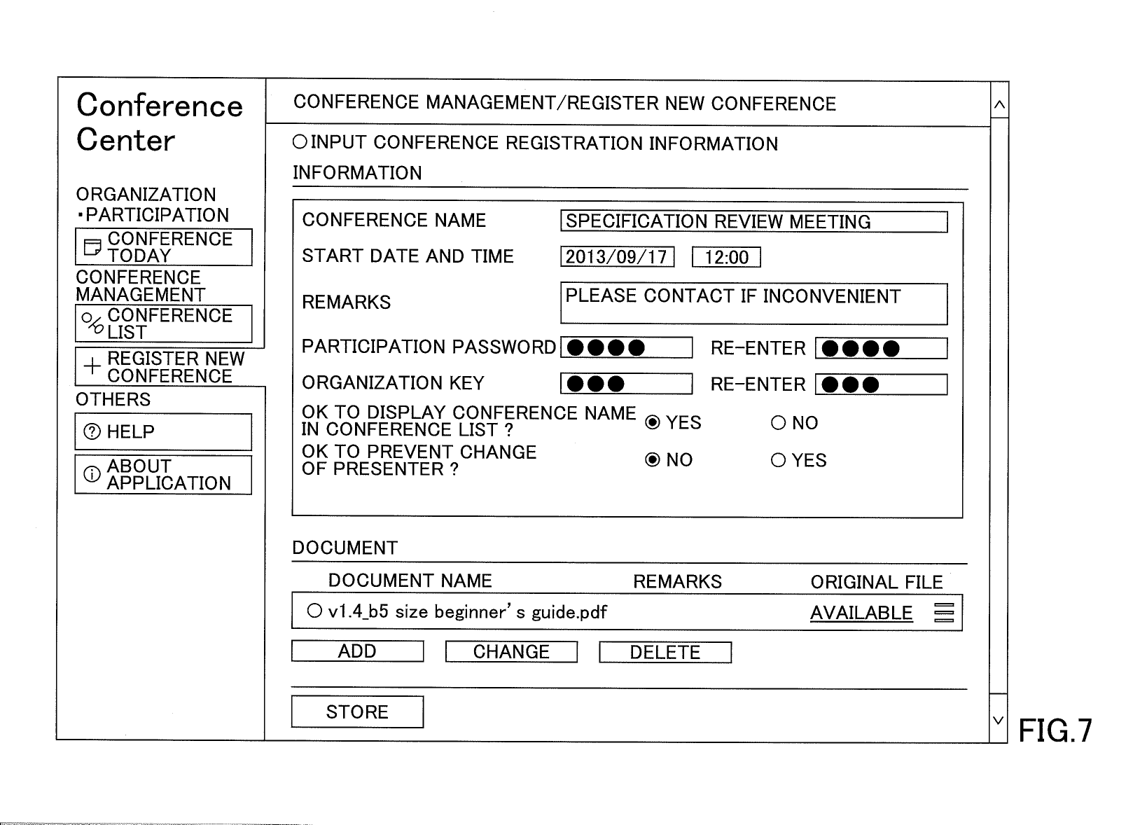

FIG. 6 is a flowchart of an example conference registration process. As illustrated in FIG. 6, for example, before generating a conference, a presenter or a host of the conference accesses a predetermined Uniform Resource Locator (URL) via the WEB browser 41 of the client terminal 10. By doing this, the WEB browser 41 of the client terminal 10 displays a conference registration screen of the conference application (S11). Here, FIG. 7 illustrates an example conference registration screen of the conference application.

In the conference registration screen of FIG. 7, the conference information and the conference data file which is to be displayed (browsed) in the conference are registered. As the conference information, for example, the conference name, the start date and time as the organized date and time, remarks, the participation password, an organization key as the organization password, a setting whether the conference name is displayed in the conference list, a setting whether the change of the presenter is prevented, etc., are registered. The conference document file is an electronic file such as, for example, a Portable Document Format (PDF) file and an Office (registered trademark) file including a document file, a spreadsheet file, a presentation file and the like.

From the content displayed on the conference registration screen described above, when, for example, a user presses the “store” button (see FIG. 7), the client terminal 10 registers the conference information and the conference document file (step S12). In the process of step S12, the conference application sends a request to the conference server apparatus 12 to register the conference information and the conference document file.

Next, the WEB server 51 of the conference server apparatus 12 divides the request to register the conference information and the conference document file into a request to register the conference information and a request to register the conference document file. Then, the conference server apparatus 12 sends the request to register the conference information to the conference server 52, and sends the request to register the conference document file to the conference document server 53. In response to the request to register the conference information, the conference server 52 stores the conference information into the conference information table illustrated in FIG. 4 (step S13). On the other hand, in response to the request to register the conference document file, the conference document server 53 stores the conference document file into the conference document DB (step S14). Further, in the process of step S14, the information of the conference document file is reflected in the document information table illustrated in FIG. 5.

Next, the conference document server 53 divides the conference document file stored in the conference document DB into separate pages of the conference document files, and converts the separate pages of the conference document files into the conference document image files (binary data) for the standard display, the enlarged display, and the thumbnail display (step S15).

Next, the conference document server 53 further converts the conference document image file for the thumbnail display into a file in a text format (i.e., the thumbnail text file) by encoding using, for example, Base 64 (step S16).

Next, the conference document server 53 stores the conference data image files and the thumbnail text file, which are converted in step S14 and 15, into the conference document DB (step S17), and the process ends.

### Conference Organization Process

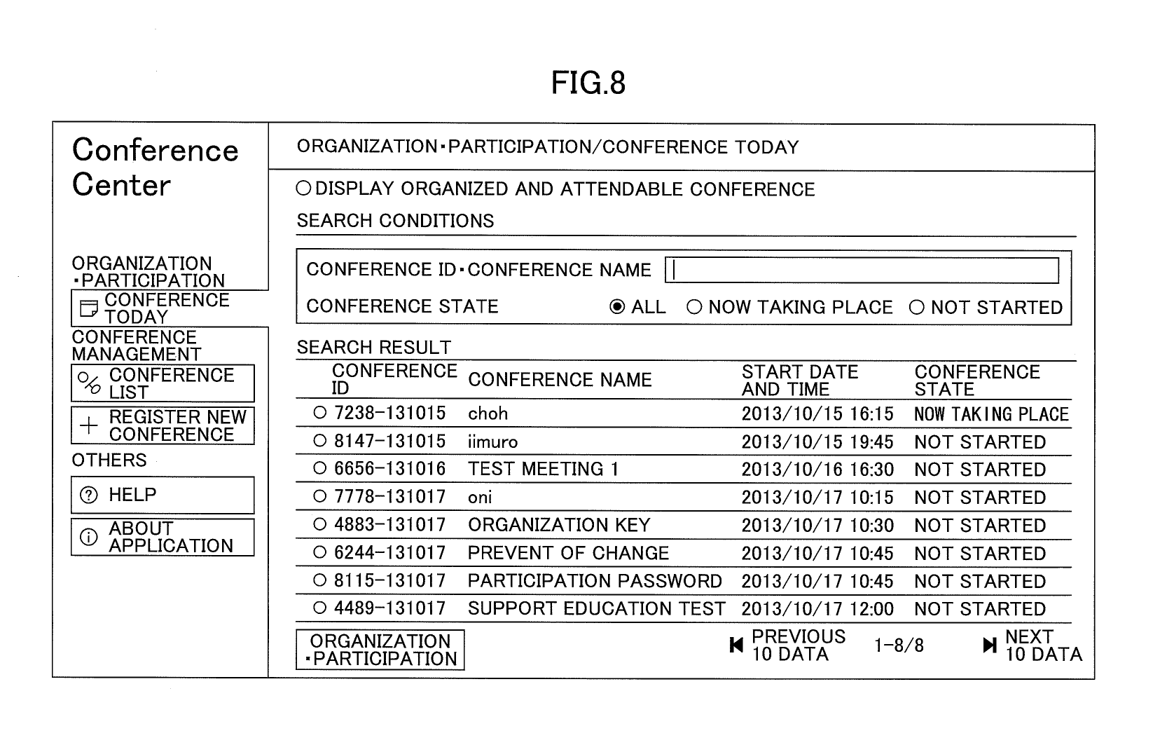

For example, when the presenter or the host of the conference selects “conference today” on the left-hand side of the conference registration screen of FIG. 7, a conference list screen as illustrated in FIG. 8 is displayed on the WEB browser 41 of the client terminal 10. FIG. 8 illustrates an example conference list screen.

The conference list screen in FIG. 8 displays the conference list stored in the conference information table in the conference server apparatus 12, so that a user can select to organize and participate in the conference. Here, the conference application running on the WEB browser 41 of the client terminal 10 acquires the conference information from the conference server apparatus 12 and display the conference list screen.

When the conference to be organized is selected on the conference list screen of FIG. 8 by the presenter of the host of the conference, the conference organization application running on the WEB browser 41 of the client terminal 10 sends a request to the conference server apparatus 12 to organize the conference. The conference server 52 of the conference server apparatus 12 that receives the request to organize the conference generates the Conference Room (“Room”) in, for example, the XMPP.

In this case, when the organization password is set in the conference information to the conference to be organized, the conference organization application prompts the presenter or the host of the conference to input the organization password and adds the input organization password to the request to organize the conference.

Further, when the “conference today” on the left-hand side of the conference registration screen of FIG. 7 is selected by the presenter or the host of the conference, the conference application displays the conference list screen of FIG. 8 on the WEB browser 41 of the client terminal 10. Then, the conference to be participated in is selected on the conference list screen of FIG. 8 by the presenter or the host of the conference, the conference organization application sends a request to the conference server apparatus 12 to participate in the conference.

The conference server 52 of the conference server apparatus 12 that receives the request to participate in the conference causes the client terminal 10 to participate in the conference by entering the client terminal 10 into the Conference Room which is provided by, for example, the XMPP. In this case, when the participation password is set in the conference information to the conference to participate in, the conference organization application prompts the presenter or the host of the conference to input the participation password and adds the input participation password to the request to participate in the conference.

Upon receiving a report that the participation in the conference is successful from the conference server apparatus 12, the client terminal 10 acquires the conference information and page information from the conference server apparatus 12. The conference information includes, for example, the number of participants in the conference, members, the information of the conference document file (e.g., the document ID, the document name, the storage location of the document (the address, the acquired URL or the like)), etc. Based on the page information, the information is reported (acquired) indicating that, for example, the page currently displayed in the conference corresponds to which page of which conference document file, etc.

The client terminal 10 sends a request to the conference server apparatus 12 to acquire the conference document image file corresponding to the page information acquired from the conference server apparatus 12. In response to the request, the conference document image file is transmitted from the conference document server 53 to the client terminal 10.

### Example Conference Screen

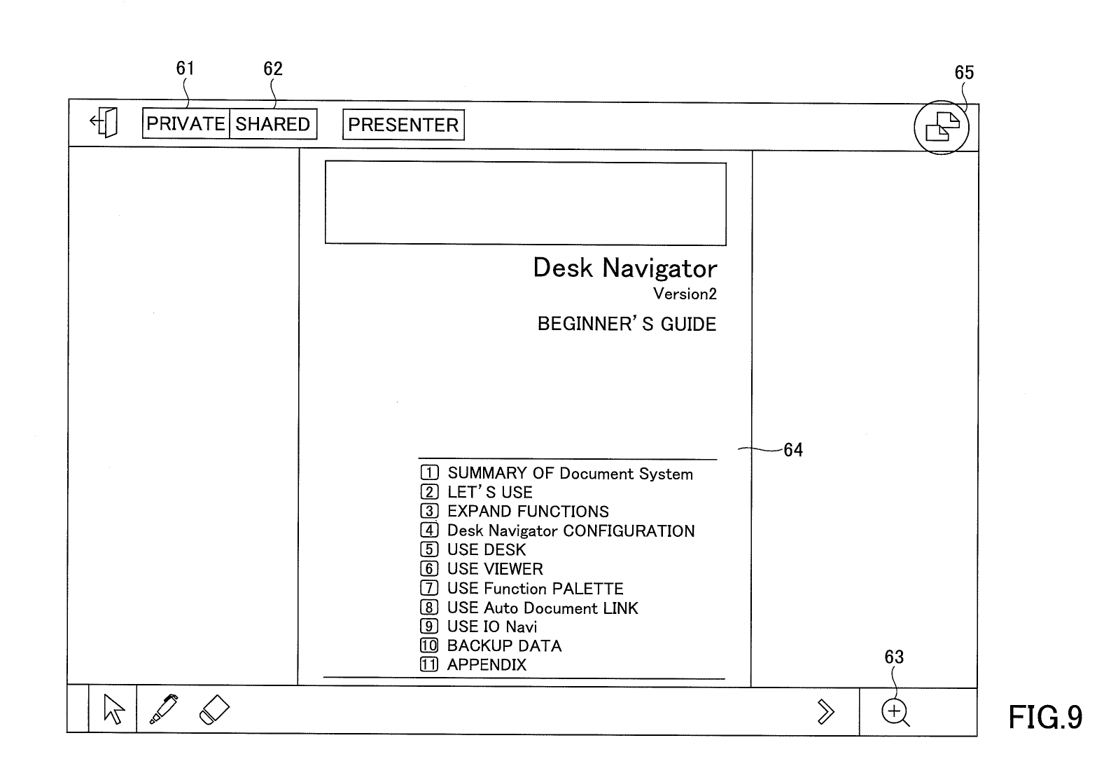

The client terminal 10 displays the conference document image file, which is downloaded by the conference organization application running on the WEB browser 41, on a conference screen as illustrated in FIG. 9. FIG. 9 illustrates an example conference screen.

The conference screen of FIG. 9 includes (displays), for example, an image 64 of the conference document image file downloaded from the conference server apparatus 12. The “private” button 61 of FIG. 9 is used when the user wishes to select (designate) a “private mode” in which the user can freely turn pages without the displayed page being in synchronization with the page that is designated (used) by, for example, the presenter of the conference. On the other hand, the “shared” button 62 of FIG. 9 is used when the user wishes to select a “shared mode” in which the image 64 is updated in synchronization with the page that is designated (used) by, for example, the presenter of the conference.

The button 63 of FIG. 9 is used to, for example, enlarge or reduce the size of the image 64 on the screen. By downloading both the conference document image files for the standard display and for the enlarged display in advance, the WEB browser 41 can switch to select the conference document image file for an appropriate display at the timing when, for example, enlargement rate setting changes across a threshold value. By doing this, it becomes possible to smoothly enlarge and reduce the size of the image 64.

The button 65 of FIG. 9 is used to switch documents or designate the page and display the thumbnail list of the conference documents. An example of the thumbnail list of the conference documents is described below.

When a button is pressed by a user, the WEB browser 41 performs display control in response to the pressed button. Based on the described conference screen of FIG. 9, the presenter and the participants in the conference can browse the conference document file.

### Thumbnail List

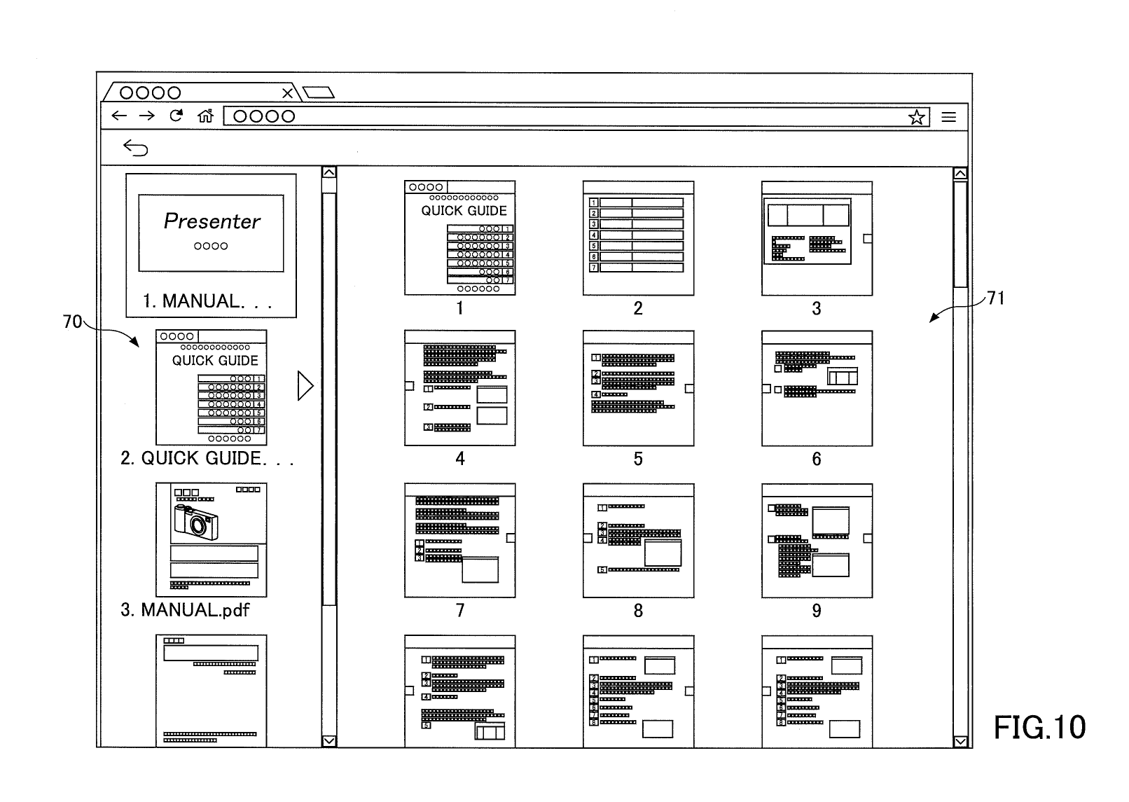

In the client terminal 10, when the button 65 on the conference screen in FIG. 9 is pressed, the conference organization application sends a request to acquire the thumbnail list of the conference documents to the conference server apparatus 12, and acquires data to display the thumbnail list from the conference server apparatus 12. FIG. 10 illustrates an example thumbnail list displayed on the conference screen.

In the left column on the screen of FIG. 10, a document thumbnail list 70 is displayed illustrating the first pages (e.g., front covers) of the documents used in the conference. In the example of FIG. 10, a case is illustrated where the documents are provided in separated files. However, note that the present invention is not limited to this configuration.

In the right column on the screen of FIG. 10, a page thumbnail list 71 is displayed illustrating the pages of the document which is selected from the document thumbnail list 70.

By selecting a thumbnail of the document to be displayed from the one or more thumbnails displayed in the document thumbnail list 70, it becomes possible to switch to display the pages of thumbnails of the elected document. Namely, when the thumbnails of the document to be displayed are switched (selected), the pages of thumbnails of the elected document are displayed in the page thumbnail list 71. Then, by selecting the thumbnail from one or more thumbnails displayed in the page thumbnail list 71, the selected page corresponding to the selected thumbnail can be displayed (i.e., it becomes possible to move to the selected page).

### Method of Transmitting Plural Images

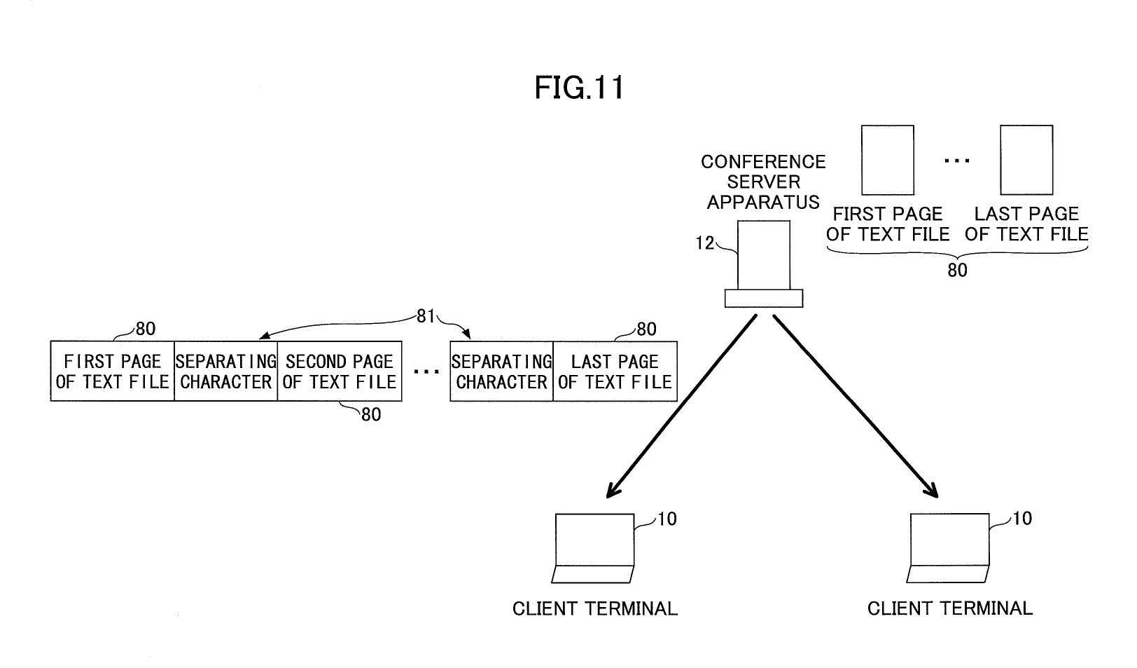

FIG. 11 illustrates a method of transmitting plural images. More specifically, FIG. 11 illustrates a method of transmitting plural images (data) from the conference document server 53 of the conference server apparatus 12 in order to display, for example, the document thumbnail list 70 and the page thumbnail list 71 of FIG. 10 on the client terminal(s) 10.

In many cases, the conference document files, which are uploaded to the conference server apparatus 12, have different image sizes (i.e., the aspect ratio expressed in the form of “width(horizontal)×height(vertical)”) as schematically illustrated in the document thumbnail list 70 of FIG. 10, and the image size (the aspect ratio) is not determined in advance. In such a case, a complicated process may become necessary when, for example, the conference server apparatus 12 generates one image based on the conference document image files having various (different) image sizes and transmits the generated one image to the client terminals 10, so that the client terminals 10 display the above-described document thumbnail list 70 based on the one image. On the other hand, if, for example, the client terminal 10 sends a request to acquire the total pages of the conference document image files, increased connection processing time may become necessary and the communication data amount may be increased.

In this regard, according to an embodiment, as illustrated in FIG. 11, first, the conference server apparatus 12 divides the conference document file into pages, and converts the divided (i.e., the pages of the) conference document image files (binary data) into the respective text files 80 (text data) by encoding using, for example, Base 64.

Upon receiving a request from the client terminal 10 to acquire, for example, the thumbnail list, the conference server apparatus 12 combines (connects) the text files 80 by adding (inserting) a separating character file 81 (character data), which indicates (serves as) a divider between the pages, between the pages of the text files 80.

In the example of FIG. 11, by inserting the separating character file 81 between the text file 80 of the first page and the text file 80 of the second page, the text file 80 of the first page and the text file 80 of the second page are combined with each other. In the same manner, the conference server apparatus 12 connects (combines) from the first page of the text file 80 to the last page of the text file 80 as a set of data, and transmits the combined text files 80 as the set of data to the client terminal 10.

By detecting the separating character file 81 inserted therebetween from the acquired set of data, the client terminal 10 divides the combined text files 80 into separated pages of the text files 80. Then, the client terminal 10 converts the separated pages of the text files 80 into the respective image files and displays the thumbnail list based on the image files.

By doing this, it becomes possible for the conference server apparatus 12 to transmit a set of data in which the image files included therein can be divided regardless of the various aspect ratios of the image files included therein as a response to a single request from the client terminal(s) 10.

When the plural files corresponding to the respective pages of the images are to be transmitted, it is possible to connect all the files to generate a set of data first and then, transmit the set of data. Otherwise, the files may be sequentially transmitted (as a set of data) while other files to be transmitted in the set of data are combined in parallel. In this regard, by appropriately select those two methods, it becomes possible to effectively transmit by determining appropriate connecting timing(s) based on, for example, a file reading state and dedicated (given) conditions.

Further, as the separating character file 81 (character data), which indicates (serves as) a divider between the pages, to be inserted between the pages of the text files 80, it is desirable to use a character which is not used in, for example, Base 64 encoding. In other words, it is desired to use one or more character codes or the like which are not included in the text file as a conversion result. Such character codes include, but not limited to, “, (comma)”, “# (sharp)”, “- (hyphen)”, “_ (under bar)”, “′ (single quotation)”, “(″) (double quotation)”, “& (ampersand)”, and “! (exclamation mark)”.

By doing this, even when it seems to be difficult for an application in JavaScript to receive binary data depending on the type of the Web browser of the client terminal(s) 10 (e.g., the Internet Explore (IE) 8 (registered trade mark)), the processing may become easier because the binary data are converted into text data first, so that the text data are transmitted.

Further, in FIG. 11, a case is described where the conference document from the first page to the last page is transmitted. However, for example, the conference document from a designated page to the last page may be transmitted. By doing this, it becomes possible to reduce the memory capacity required to store the conference document.

### Image Transmission Process

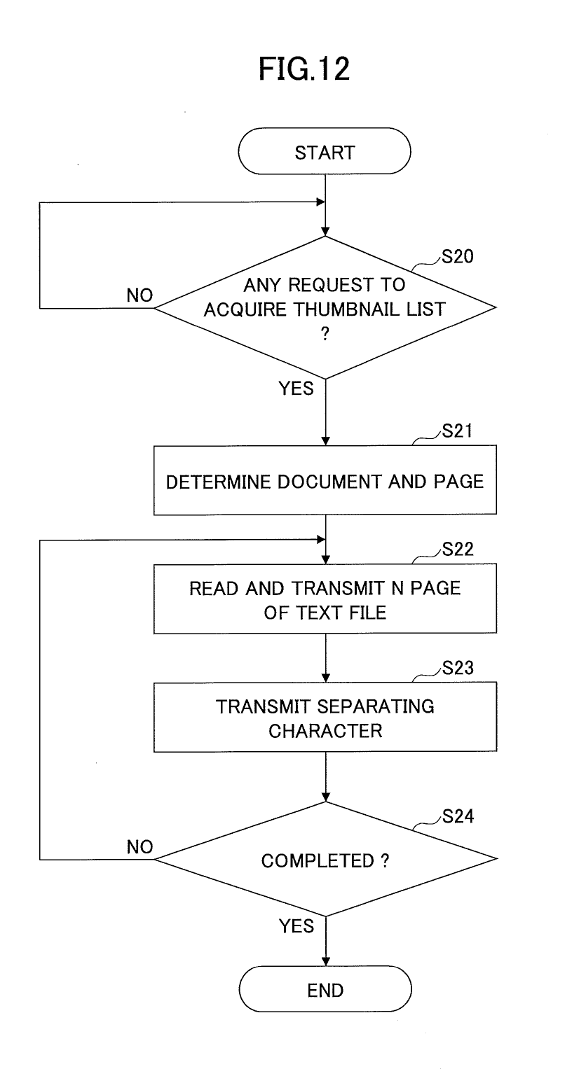

FIG. 12 is a flowchart of an example image transmission process of the conference server apparatus 12. As illustrated in FIG. 12, the conference server apparatus 12 determines whether the conference document server 53 of the conference server apparatus 12 receives a request to acquire the thumbnail list from the client terminals 10 (step S20). Here, the “thumbnail list” in step S20 refers to one of the document thumbnail list 70 and the page thumbnail list 71 or both.

When the conference server apparatus 12 determines that the conference document server 53 receives the request to acquire the thumbnail list (YES in step S20), the conference server apparatus 12 determines the conference document and the pages relevant to the requested thumbnail list (step S21). On the other hand, when it is determined that the request to acquire the thumbnail list is not received (NO in step S20), the process in step S20 is repeated.

Next, the conference document server 53 of the conference server apparatus 12 reads the text file corresponding to the N pages of the conference document determined in step S21 from the conference document DB and transmit the read text file to the client terminal 10 (step 22). Next the conference document server 53 of the conference server apparatus 12 transmits the separating character file 81 to the client terminal 10 (step 23).

Next, the conference document server 53 of the conference server apparatus 12 determines whether all pages relevant to the request to acquire the thumbnail list are transmitted (transmission is “completed ?”) (step S24). When it is determined that all pages are not transmitted (NO in step S24), the process goes back to step S22. On the other hand, when it is determined that all pages are transmitted (YES in step S24), the process ends.

### Thumbnail List Display Process

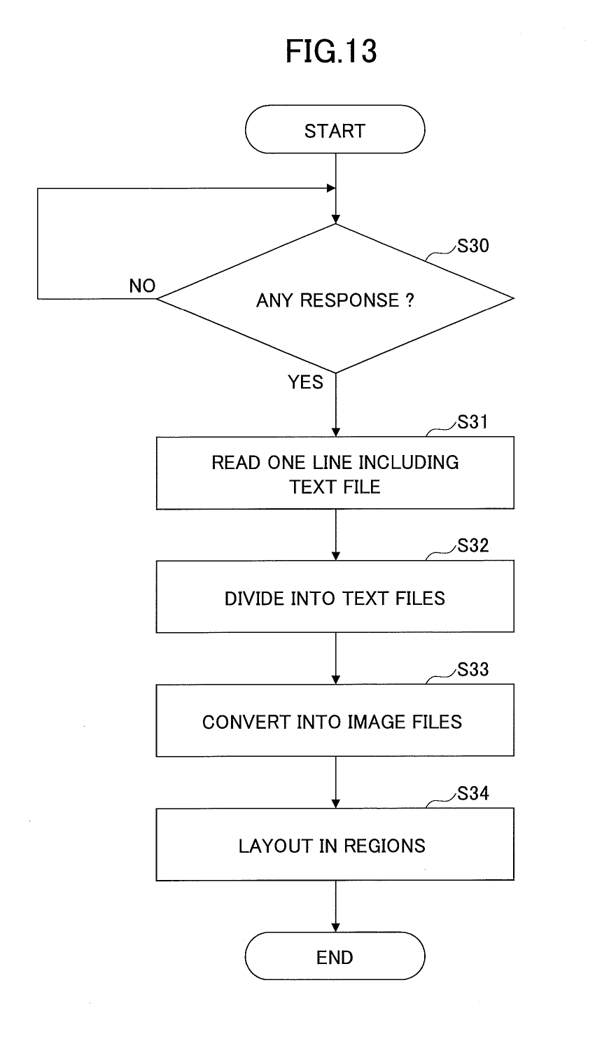

FIG. 13 is a flowchart of an example thumbnail list display process. As illustrated in FIG. 13, the client terminal 10 determines whether the WEB browser 41 receives a response from the conference server apparatus 12 in response to the request to acquire the thumbnail list (step S30).

When the client terminal 10 determines whether the WEB browser 41 of the client terminal 10 receives the response from the conference server apparatus 12 (YES in step S30), the client terminal 10 reads one line where, for example, a text file is included from the response (step S31). When it is determined that no response is received, the process in step S30 is repeated.

When the client terminal 10 detects the separate character in the one line in which the text file read in the process of step S31 is included, the client terminal 10 divides the response into the text files (step S32). Next, the WEB browser 41 of the client terminal 10 converts the divided text files by the process in step S32 into the respective image files (i.e., the conference document image files for thumbnail display) (step S33).

Next, the client terminal 10 lays out the image files in the respective regions of the thumbnail list displayed on the conference screen (step S34), and the process ends. By doing this, it becomes possible for the client terminal 10 to display the thumbnail list on the conference screen even when, for example, the conference document files have different screen sizes (i.e., the aspect ratio expressed in the form of “width(horizontal)×height(vertical)”).

### Example Request and Response

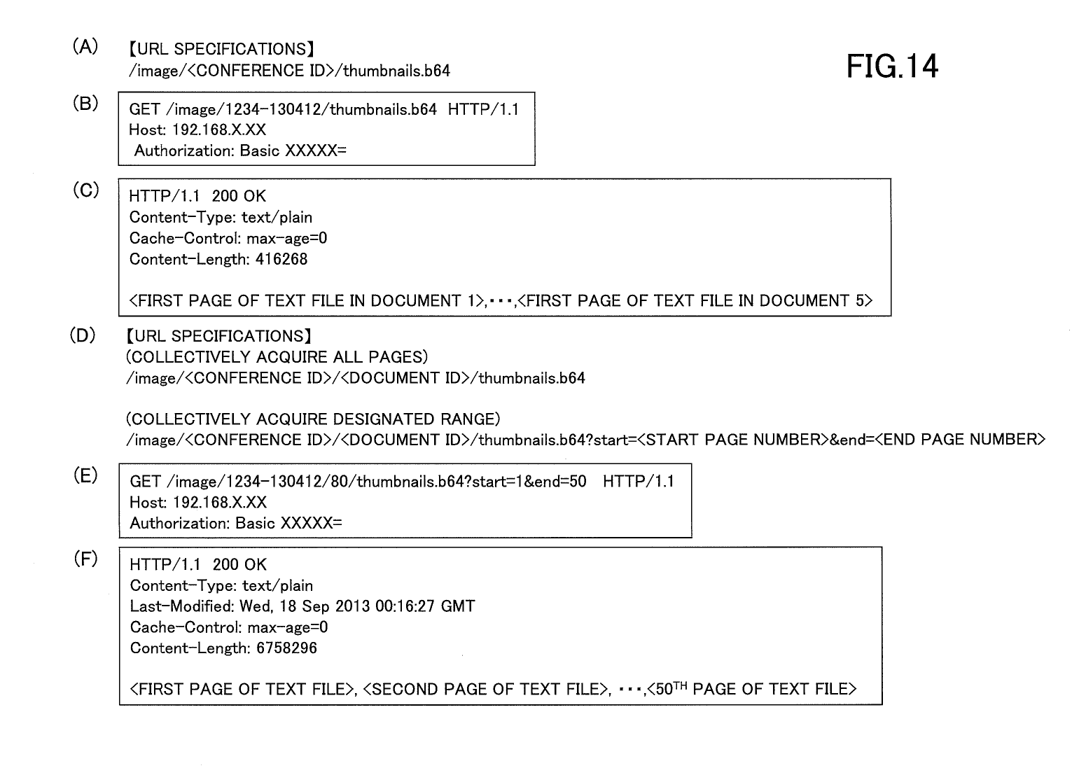

FIG. 14 illustrates example request data and response data. More specifically, part (A) through part (C) of FIG. 14 illustrate example request data to acquire the document thumbnail list 70 and response data thereto. On the other hand, part (D) through part (F) of FIG. 14 illustrate example request data to acquire the page thumbnail list 71 corresponding to a predetermined document ID and response data thereto.

Part (A) and part (D) of FIG. 14 illustrate example URL specifications used when a request is sent from the client terminal 10 to the conference server apparatus 12 based on HTTP. Note that the request format and the like are not limited to the example. Part (A) of FIG. 14 illustrates an example to collectively acquire one or more document data images used for the conference identified by the conference ID as the text file encoded by using, for example, Base64.

The client terminal 10 sends a request to the conference server apparatus 12 by using a GET command and specifically setting the host address and the like as illustrated in part (B) of FIG. 14. The conference server apparatus 12 acquires the data corresponding to the requested conference ID (e.g., “1234-130412”), connects the first pages of the text files of the documents using the separating character as illustrated in part (C) of FIG. 14, and transmits the connected (combined) text file to the client terminal 10.

Further, when the pages corresponding to the selected document ID are acquired among plural documents used in a predetermined conference ID, the client terminal 10 generates an HTTP request based on the specifications as illustrated in part (D) of FIG. 14 according to, for example, user's instructions. Specifically, the client terminal 10 generates, for example, a request to collectively acquire the document from the first page to the fiftieth page corresponding to the document ID as illustrated in part (E) of FIG. 14 and sends the request to the conference server apparatus 12.

The conference server apparatus 12 acquires the data corresponding to the request illustrated in part (E) of FIG. 14, connects (combines) the text files of those pages of the document using the separating character, and transmits the combined data to the client terminal 10 related to the received request.

In this embodiment, as illustrated, for example, in part (C) and part (F) of FIG. 14, the conference server apparatus 12 connects (combines) the pages of the text file(s) to each other using the separating character to generate a set of data, and transmits the plurals images (conference document image files) to be displayed on the client terminal 10.

In this embodiment, in order to display the thumbnail list, a case is described where the conference document image file, which is converted for the thumbnail display, is converted into the text file. However, the present invention is not limited to this configuration. For example, the conference document image file, which is converted for the standard display or the enlarged display, may be converted into the text file.

Further, in the above description, a case is described where the text files are connected to each other using the separating character file and the connected text files are transmitted. However, the present invention is not limited to this configuration. For example, separating information (a control code such as a linefeed code) corresponding to the “separating character” may be determined based on a format used between the server and the client, so that the plural images (binary data) are connected to each other using the separating information and the connected data are transmitted.

As described above, according to this embodiment, it becomes possible to effectively output data. In the above embodiment, a case is described where the conference document is distributed. However, the present invention is not limited to this configuration. For example, the present invention may also be applied to a case where, for example, documents are distributed to students, participants, etc., in the classes, seminars, meetings, events, etc., in educational fields, service enterprises, etc.

According to an embodiment, it becomes possible to effectively output data.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

The present invention can be implemented in any convenient form, for example using dedicated hardware, or a mixture of dedicated hardware and software. The present invention may be implemented as computer software implemented by one or more networked processing apparatuses. The network can comprise any conventional terrestrial or wireless communications network, such as the Internet. The processing apparatuses can compromise any suitably programmed apparatuses such as a general purpose computer, personal digital assistant, mobile telephone (such as a Wireless Application Protocol (WAP) or 3G-compliant phone) and so on. Since the present invention can be implemented as software, each and every aspect of the present invention thus encompasses computer software implementable on a programmable device. The computer software can be provided to the programmable device using any storage medium for storing processor readable code such as a floppy disk, hard disk, CD ROM, magnetic tape device or solid state memory device.

The hardware platform includes any desired kind of hardware resources including, for example, a CPU, a RAM, and an HDD. The CPU may be implemented by any desired kind of any desired number of processors. The RAM may be implemented by any desired kind of volatile or non-volatile memory. The HDD may be implemented by any desired kind of non-volatile memory capable of storing a large amount of data. The hardware resources may additionally include an input device, an output device, or a network device, depending on the type of the apparatus. Alternatively, the HDD may be provided outside of the apparatus as long as the HDD is accessible. In this example, the CPU, such as a cache memory of the CPU, and the RAM may function as a physical memory or a primary memory of the apparatus, while the HDD may function as a secondary memory of the apparatus.

What is claimed is:

1. An information processing apparatus that is connected to at least one terminal apparatus via a network, comprising:
an acquisition part configured to acquire a set of data corresponding to a request from the terminal apparatus; and
an output control part configured to, when the acquisition part acquires plural sets of data, connect the plural sets of data to each other by inserting separating information between two sets of the data, and transmit the connected plural sets of data to the terminal apparatus.

2. The information processing apparatus according to claim 1,
wherein the acquisition part is configured to acquire the set of data as text files that are divided on a predetermined unit basis, and
wherein the output control part is configured to connect the divided text files to each other by inserting a character that is not included in the text files as the separating information.

3. The information processing apparatus according to claim 1,
wherein the acquisition part is configured to acquire the set of data as image files that are divided on a predetermined unit basis, and
wherein the output control part is configured to connect the divided text files to each other by inserting a control code that is used as the separating information.

4. The information processing apparatus according to claim 2,
wherein the acquisition part is configured to acquire the text files that are divided on a page basis for thumbnail display, and
wherein the output control part is configured to connect the text files that are divided on the page basis for the thumbnail display to each other by inserting a character that is not included in the text files.

5. An information processing method that is executed in an information processing apparatus that is connected to at least one terminal apparatus via a network, the method comprising:
an acquisition step of acquiring a set of data corresponding to a request from the terminal apparatus; and
an output control step of, when plural sets of data are acquired in the acquisition step, connecting the plural sets of data to each other by inserting separating information between two sets of the data, and transmitting the connected plural sets of data to the terminal apparatus.

6. The information processing method according to claim 5,
wherein, in the acquisition step, the set of data is acquired as text files that are divided on a predetermined unit basis, and
wherein, in the output control step, the divided text files are connected to each other by inserting a character that is not included in the text files as the separating information.

7. The information processing method according to claim 5,
wherein, in the acquisition step, the set of data is acquired as image files that are divided on a predetermined unit basis, and
wherein, in the output control step, the divided image files are connected to each other by inserting a control code that is used as the separating information.

8. The information processing method according to claim 6,
wherein, in the acquisition step, the text files that are divided on a page basis for thumbnail display are acquired, and
wherein, in the output control step, the text files that are divided on the page basis for the thumbnail display are connected to each other by inserting a character that is not included in the text files.

9. An information processing system comprising:
a terminal apparatus; and
an information processing apparatus that is connected to the terminal apparatus via a network,
wherein the information processing apparatus includes
an acquisition part configured to acquire a set of data corresponding to a request from the terminal apparatus; and
an output control part configured to, when the acquisition part acquires plural sets of data, connect the plural sets of data to each other by inserting separating information between two sets of the data, and transmit the connected plural sets of data to the terminal apparatus, and
wherein the terminal apparatus includes
a display control part configured to divide the connected plural sets of data into the plural sets of data by using the separating information and display the divided plural sets of data.

10. The information processing system according to claim 9,
wherein the acquisition part is configured to acquire the set of data as text files that are divided on a predetermined unit basis,
wherein the output control part is configured to connect the divided text files to each other by inserting a character that is not included in the text files as the separating information, and
wherein the display control part is configured to divide the connected text files into the divided text files by using the character and display the divided text files.

11. The information processing system according to claim 9,
wherein the acquisition part is configured to acquire the set of data as image files that are divided on a predetermined unit basis,
wherein the output control part is configured to connect the divided image files to each other by inserting a control code that is used as the separating information, and
wherein the display control part is configured to divide the connected image files into the divided image files by using the control code and display the divided image files.

12. The information processing system according to claim 10,
wherein the acquisition part is configured to acquire the text files that are divided on a page basis for thumbnail display,
wherein the output control part is configured to connect the text files that are divided on the page basis for the thumbnail display to each other by inserting a character that is not included in the text files, and
wherein the display control part is configured to divide the connected text files into the divided text files by using the character and display the divided text files.
